(19) United States
(12) Patent Application Publication
(10) Pub. No.: US 2015/0347397 A1
(43) Pub. Date: Dec. 3, 2015

(54) METHODS AND SYSTEMS FOR ENRICHING STATISTICAL MACHINE TRANSLATION MODELS

(71) Applicant: Xerox Corporation, Norwalk, CT (US)

(72) Inventor: Sriram Venkatapathy, Grenoble (FR)

(73) Assignee: Xerox Corporation, Norwalk, CT (US)

(21) Appl. No.: 14/294,232

(22) Filed: Jun. 3, 2014

(51) Int. Cl. G06F 17/28

(52) U.S. Cl. CPC G06F 17/289

(57) ABSTRACT

Methods and systems for enriching translation models. The first strength metric associated with a phrase in a first translation model is determined. The second strength metric associated with the phrase is received from at least one second translation model. The first translation model is enriched based on one or more translations of the phrase received from the at least one second translation model. The one or more translations are received based on a comparison between the first strength metric and the second strength metric.

### TECHNICAL FIELD

The presently disclosed embodiments are related, in general, to translation models. More particularly, the presently disclosed embodiments are related to methods and systems for enriching statistical machine translation (SMT) models.

### BACKGROUND

Machine translation refers to a field in which a phrase corresponding to a speech or text may be translated from one language (hereinafter, also referred to as source language) to other language (hereinafter, also referred to as target language), using software. Some examples of the machine translation techniques may be statistical machine translation, rule based machine translations, example-based machine translations and so forth. Different machine translation techniques may employ different methods for achieving the translations. For example, in statistical machine translations, translation from one language to the other is achieved via analyzing statistical properties associated with the source and target languages (e.g., probability distribution of the text, etc.).

Typically, machine translation models may be domain-specific or general-purpose machine translation models. Further, the machine translation models may be trained/adapted to different domains (e.g., healthcare, finance, weather-reports, etc.). Machine translation models trained on one domain may not work well for other domains. For example, a machine translation model trained for healthcare domain may not perform well, if deployed for financial applications. In such a scenario, generally, machine translation models are adapted to specific domains, using other domain-specific machine translation models. However, the machine translation models are typically adapted by accessing other domain-specific models in entirety, thus leading to increased costs for training/adapting the machine translation model.

### SUMMARY

According to embodiments illustrated herein, there is provided a method for enriching a first translation model. The method includes determining a first strength metric associated with a phrase in the first translation model. The method further includes receiving a second strength metric associated with the phrase, from at least one second translation model. The method further includes enriching the first translation model, based on one or more translations of the phrase received from the at least one second translation model. The one or more translations are received based on a comparison between the first strength metric and the second strength metric. The method is performed by one or more processors.

According to embodiments illustrated herein, there is provided a method for translating a phrase. The method includes determining a first strength metric associated with the phrase in a first translation model. The method further includes receiving a second strength metric associated with the phrase, from at least one second translation model. The method further includes translating the phrase using the first translation model, when the first strength metric is greater than the second strength metric. The method is performed by one or more processors.

According to embodiments illustrated herein, there is provided a system for enriching a first translation model. The system includes one or more processors operable to determine a first strength metric associated with a phrase in the first translation model. The one or more processors are further operable to receive a second strength metric associated with the phrase, from at least one second translation model. The one or more processors are further operable to enrich the first translation model, based on one or more translations of the phrase received from the at least one second translation model. The one or more translations are received based on a comparison between the first strength metric and the second strength metric.

According to embodiments illustrated herein, there is provided a computer program product for use with a computer. The computer program product includes a non-transitory computer readable medium. The non-transitory computer readable medium stores a computer program code for enriching a first translation model. The computer program code is executable by one or more processors to determine a first strength metric associated with a phrase in the first translation model. The computer program code is further executable by the one or more processors to receive a second strength metric associated with the phrase, from at least one second translation model. The computer program code is further executable by the one or more processors to enrich the first translation model, based on one or more translations of the phrase received from the at least one second translation model. The one or more translations are received based on a comparison between the first strength metric and the second strength metric.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating an application server for enriching a first translation model, in accordance with at least one embodiment;

FIG. 3 is a flowchart illustrating a method for enriching a first translation model, in accordance with at least one embodiment; and

FIG. 4 is a flowchart illustrating a method for translating a phrase, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### DEFINITIONS

The following terms shall have, for the purposes of this application, the respective meanings set forth below.

A “machine translation” refers to a process of translating a phrase from source language to target language. The phrase may correspond to a text or a speech input, provided by a user. In an embodiment, the translation of the phrase is achieved via statistical machine translation.

A “machine translation model” refers to a computer data-structure that translates the phrases from the source language to the target language. In an embodiment, the machine translation model may refer to a statistical machine translation (i.e., SMT) model that utilizes statistical properties associated with the phrases (e.g., probability distribution of the words, syllables in the phrases) to translate the phrases from the source language to the target language. Further, the SMT model may include one or more phrase tables that include the information pertaining to the translation of the phrases.

A “phrase” refers to a combination of letters, words, syllables, sentences and the like. In an embodiment, the phrases may include text or speech input provided by a user. The user may provide the text input using various input devices (e.g., keyboard, a computer-mouse, a joystick, a touch interface and the like). Further, the user may provide the speech input using a device that includes a microphone. In an embodiment, the user may provide the inputs corresponding to the phrase in the source language and want the phrase to be translated in the target language.

A “domain” refers to a field or an area to which the phrase belongs. For example, the phrases may belong to different domains such as, but not limited to, healthcare, financial, technical, legislative, etc.

“Enriching” refers to a process of updating/adapting/training an SMT model to a particular domain. In an embodiment, an SMT model that corresponds to one domain may be adapted to other domains by downloading translations corresponding to the phrases from one or more domain-specific SMT models. In an alternative embodiment, an SMT model that does not include any translation may be enriched with one or more domains by downloading translations corresponding to the phrases from the one or more domain-specific SMT models.

A “first translation model” refers to a SMT model that needs to be enriched in one or more domains. In an embodiment, the first translation model may correspond to a general-purpose SMT model that may be utilized for any domain, and may need to be enriched with one or more domain-specific SMT models, such that the enriched model may be utilized in the corresponding domain with higher translation accuracies. In an embodiment, the first translation model includes one or more first phrase tables that may further include phrases and corresponding translations.

A “second translation model” refers to an SMT model, using which the first translation model is enriched. In an embodiment, the second translation model may be domain-specific translation model. The second translation model may include one or more second phrases tables including phrases and corresponding translations in one or more languages. In an embodiment, the first translation model may be enriched using the one or more translations from the second translation models.

A “first strength metric” refers to a measure of translatability of the phrase by the first translation model. Thus, the first strength metric indicates the evidence in favor of the phrase to be translated well. In an embodiment, the first strength metric corresponds to a pointwise-partitioned conditional entropy. In an embodiment, higher value of the first strength metric indicates that the first translation model has greater probability to translate the phrase.

A “second strength metric” refers to a measure of translatability of the phrase by the second translation model. In an embodiment, the second strength metric also corresponds to a pointwise-partitioned conditional entropy.

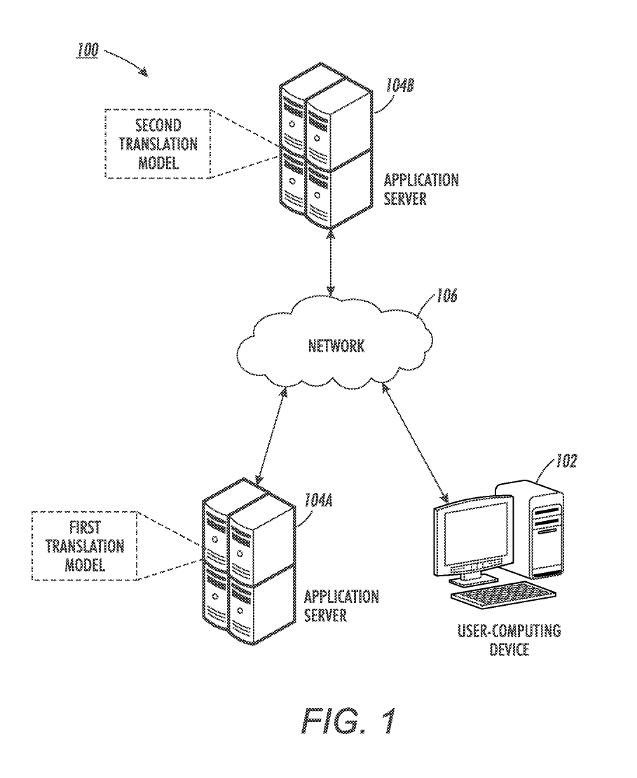

FIG. 1 is a block diagram illustrating a system environment 100 in which various embodiments may be implemented. The system environment 100 includes a user-computing device 102, an application server 104a, an application server 104b, and a network 106. Various devices in the system environment 100 (e.g., the user-computing device 102, the application server 104a, and the application server 104b) may be interconnected over the network 106.

The user-computing device 102 refers to a computing device, used by a user who wants to translate a phrase from a source language to a target language. The user may use the user-computing device 102 to provide inputs (e.g., text input or speech input) corresponding to the phrase. For example, using input devices associated with the user-computing device 102 (e.g., a keyboard, a computer-mouse, a joystick, a touch interface, etc.), the user may provide text inputs that need to be translated. Similarly, the user may provide speech inputs using the user-computing device 102. In an embodiment, a client application provided by the application server 104a may be installed on the user-computing device 102, and the user may provide inputs using the client application. In an alternate embodiment, the users may access the application server 104a, over the network 106, to provide the inputs using the user-computing device 102. The user-computing device 102 may include a variety of computing devices, such as a desktop, a laptop, a personal digital assistant (PDA), a tablet computer, and the like.

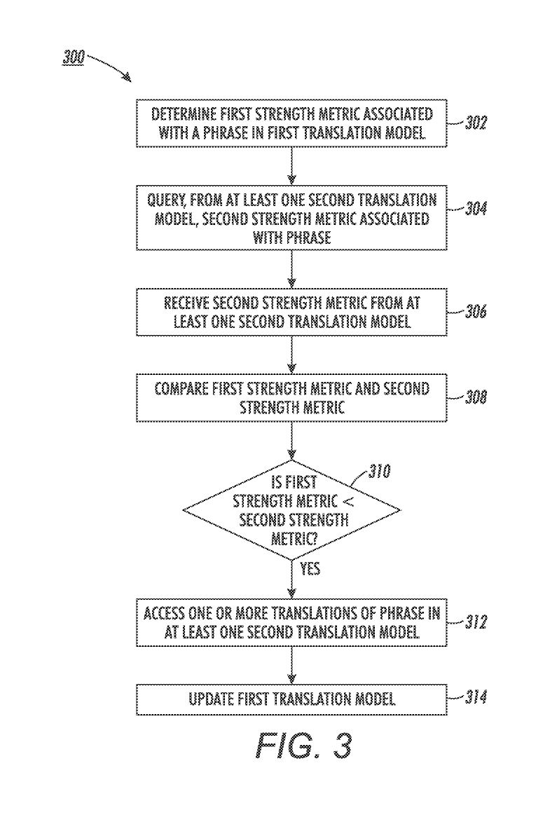

The application server 104a refers to a computing device that may translate the phrases, from the source language to the target language. In an embodiment, the application server 104a may host the first translation model to translate the phrases. The first translation model includes one or more first phrase tables that further include one or more translations of the phrases. The first translation model hosted on the application server 104a may receive the inputs corresponding to the phrases from the user-computing device 102 (e.g., using a web interface or the client application) and may translate the phrase using the one or more translations. Further, in an embodiment, the application server 104a may determine a first strength metric associated the phrase. Further, the application server 104a may query the application server 104b for second strength metric associated with the same phrase. The first translation model hosted on the application server 104a may receive one or more translations from the second translation model hosted on the application server 104b based on the comparison between the first strength metric and the second strength metric. The received one or more translations are used for enriching the first translation model. Further details about enriching the first translation model have been discussed in conjunction with FIG. 3. The application server 104a may be realized through various types of application servers such as, but not limited to, Java application server, .NET framework, and Base4 application server.

It will be apparent to a person skilled in the art that the one or more phrase tables corresponding to the first translation model may also be stored in a separate database server (not shown in the FIG. 1), without departing from the scope of the invention. In such a scenario, the database server may receive a query from the application server 104a to provide the one or more translations corresponding to a phrase. For querying the database server, one or more querying languages may be utilized such as, but are not limited to, SQL, QUEL, DMX and so forth. Further, the database server may be realized through various technologies, such as, but not limited to, Microsoft® SQL server, Oracle, and My SQL, and may be connected to application server 104a, using one or more protocols such as, but not limited to, ODBC protocol and JDBC protocol.

The application server 104b refers to a computing device that hosts the one or more second translation models. In an embodiment, the one or more second translation models may include one or more phrase tables that may further include the phrases and corresponding translations. The one or more second translation models hosted on the application server 104b may be utilized for enriching the first translation model. In an embodiment, the application server 104b may receive a query from the application server 104a for providing the second strength metric associated with the phrase. The application server 106 may provide the second strength metric to the application server 104a based on the received query. The application server-2 106a may be realized through various types of application servers such as, but not limited to, Java application server, .NET framework, and Base4 application server.

It will be apparent to a person skilled in the art that the one or more phrase tables corresponding to the second translation models may also be stored in a separate database server (not shown in FIG. 1).

Further, it will be apparent to a person skilled in the art that the functionalities of the application server 104a, the application server 104b, and the database server may be combined in a single server, without departing from the scope of the disclosure. In such a scenario, the SMT model corresponding to the first domain and the second domain may be hosted by the single server.

The network 106 corresponds to a medium through which content and messages flow between various devices of the system environment 100 (e.g., the user-computing device 102, the application server 104a, and the application server 104b). Examples of the network 106 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 106 in accordance with the various wired and wireless communication protocols such as Transmission Control Protocol and Internet Protocol (TCP/IP), User Datagram Protocol (UDP), and 2G, 3G, or 4G communication protocols.

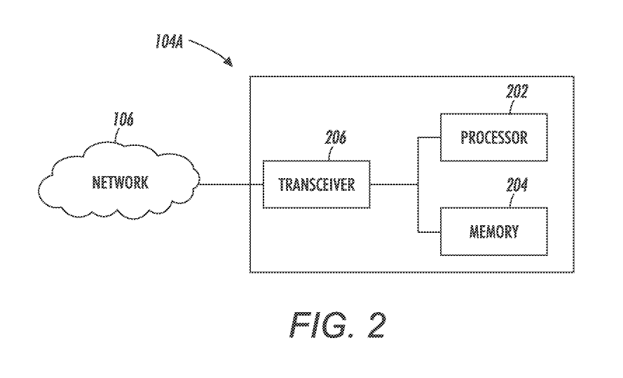

FIG. 2 is a block diagram illustrating the application server 104a, in accordance with at least one embodiment. The application server 104a includes a processor 202, a memory 204, and a transceiver 206.

The processor 202 is coupled to the memory 204 and the transceiver 206. The processor 202 includes suitable logic, circuitry, and/or interfaces that are operable to execute one or more instructions stored in the memory 204 to perform predetermined operation. The memory 204 may be operable to store the one or more instructions. The processor 202 may be implemented using one or more processor technologies known in the art. Examples of the processor 202 include, but are not limited to, an X86 processor, a RISC processor, an ASIC processor, a CISC processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person having ordinary skills in the art that the one or more instructions stored in the memory 204 enables the hardware of the application server 104a to perform the predetermined operation.

The transceiver 206 transmits and receives messages and data to/from various components of the system environment 100. Examples of the transceiver 206 may include, but are not limited to, an antenna, an Ethernet port, an USB port or any other port that can be configured to receive and transmit data. The transceiver 206 transmits and receives data/messages in accordance with the various communication protocols, such as, TCP/IP, UDP, and 2G, 3G, or 4G communication protocols.

The operation of the application server 104a for enriching the first translation model has been described in conjunction with FIG. 3.

FIG. 3 is a flowchart 300 illustrating a method for enriching a first translation model, in accordance with at least one embodiment. In an embodiment, the method for enriching the first translation model is implemented on the application server 104a. The flowchart 300 is described in conjunction with FIG. 1 and FIG. 2.

At step 302, the first strength metric associated with the phrase is determined. In an embodiment, prior to determining the first strength metric, the processor 202 may receive a phrase from the user-computing device 102. Post receiving the phrase, the processor 202 may determine the first strength metric associated with the phrase. In an embodiment, the memory 204 may include the first translation model. Further, the memory 204 may include the one or more phrase tables associated with the first translation model. As discussed, the one or more phrase tables may include various phrases (e.g., in the form of letters, words, syllables, phrases, sentences, etc.) and corresponding translation of the phrases. Table 1 provided below illustrates a phrase table:

TABLE 1
Illustration of the phrase table

| | | | Forward | Inverse | | |
|---|---|---|---|---|---|---|
| | | | Transla- | Transla- | Forward | Backward |
| | Trans- | | tion | tion | Lexical | Lexical |
| Source | lated | Occur- | Proba- | Proba- | Weight- | Weight- |
| Phrase | Phrase | rences | bility | bility | ing | ing |
| This is | Das ist | 3 | 0.17 | 0.18 | 0.18 | 0.11 |
| der | The | 1 | 0.6 | 0.53 | 0.21 | 0.24 |

Table 1 illustrates that phrase table includes various types of information about the occurrence of the phrases and their translations. For example, it can be observed that the phrase “This is” occurs 3 times and the probability of its translation (i.e., “Das ist”) being available in the phrase table is 0.17. It will be understood by a person skilled in the art that Table 1 has been provided for illustration purposes and may include more parameters than exemplified.

In an embodiment, prior to receiving the phrase, the first translation model may be enriched to a specific domain (e.g., medical, engineering, legal, etc.). The first translation model may be enriched using a parallel corpus corresponding to the domain.

In an embodiment, the first strength metric associated with the phrase corresponds to a pointwise-partitioned conditional entropy that denotes the translatability of the phrase by the first translation model. In an embodiment, the pointwise-partitioned conditional entropy is determined based on a count of the one or more translations of the phrase in the phrase table associated with the first translation model, and a number of occurrence of the phrase in the phrase table associated with the first translation model. The count of the occurrence of the one or more translations of the phrase denotes the options available to translate the phrase, whereas number of occurrence of the phrase in the first translation model denotes how frequently the phrase appears in the phrase table associated with the first translation model.

For example, a user wants to translate a phrase “This is”. The phrase may be received by the application server 104a. Subsequently, the application server 104a may refer to following phrase table (refer Table 1) to determine the translated text. The application server 104a determines the number of occurrences of the phrase “This is” in the phrase table, which is “3”. Additionally, the application server 104a determines the frequency of appearance of the translation of the phrase in the phrase table (i.e., “Das ist”). Thereafter, the application server 104a may determine the first strength metric corresponding to the phrase “This is”. In an embodiment, following equation is used for determining the occurrence of the translation of the phrase:

H(T|s)=Σₜp(t|s)*log p(t|s) (1)

where,

p(t|s)=probability of availability of the one or more translations for the phrase in the first translation model.

In an embodiment, the pointwise-partitioned conditional entropy associated with the phrase is determined through below provided equation:

φ(s)=H(T|s)*p(s) (2)

where,

φ(s)=pointwise-partitioned conditional entropy (i.e. first strength metric) associated with the phrase in the first translation model,

H(T|s)=conditional entropy (described in conjunction with equation (1)) associated with the phrase in the first translation model, and

p(s)=probability of occurrence of the phrase in the first translation model.

From equation 2, it can be observed that higher the value of the count of occurrence of the one or more translations of the phrase (i.e., H(T|s)) and the number of occurrence of the phrase (i.e., p(s)), higher will be the value of the first strength metric (i.e., φ(s)).

At step 304, at least one second translation model is queried. The processor 202 may query the at least one second translation model that may be hosted in the application server 104b, for extracting the second strength metric associated with the phrase. In an embodiment, the processor 202 transmits the phrase, for which the second strength metric is to be extracted, to the application server 104b. In response to the query, the at least one second translation model of the application server 104b determines the second strength metric associated with the phrase. The second strength metric determined by the at least one second translation model corresponds to the same phrase for which the first strength metric was determined by the first translation model (in conjunction with the step 302). Further, the second strength metric may be determined by using the equation (1), as disclosed in conjunction with the step 302.

At step 306, the second strength metric is received. The processor 202 receives the second strength metric from the at least one second translation model hosted on the application server 104b.

At step 308, the first strength metric and the second strength metric are compared. The processor 202 compares the first strength metric (as determined in conjunction with the step 302) and the received second strength metric (in conjunction with the step 306). It will be apparent to a person skilled in the art that based on the conditional entropy (as defined in equation (2)) and the number of occurrence of the phrase in the at least one second translation model (i.e., p(s)), the second strength metric may be less or greater than the first strength metric.

At step 310, it is determined whether the first strength metric is less than the second strength metric. If the first strength metric is less than the second strength metric, step 312 is performed.

At step 312, the one or more translations in the at least one second translation model are accessed. It will be apparent that the one or more translations in the at least one second translation model are accessed if the processor 202 determines that the at least one second translation model has better translation options (i.e., the higher value of the strength metric) of the phrase than the first translation model.

In an alternate embodiment, the processor 202 may compare the first strength metric with more than one second strength metrics (from more than one second translation models). In such a scenario, the processor 202 may access the one or more translations in the second translation model with highest value of the second strength metric (assuming the first strength metric has not the highest value).

At step 314, the first translation model is enriched. The processor 202 may enrich the first translation model based on the one or more translations accessed in the at least one second model (as disclosed in the step 312). In an embodiment, the processor 202 receives the one or more translations from the at least one second translation model and replaces the one or more translations in the first translation model with the received one or more translations. In an embodiment, one or more statistical parameters associated with the phrase in the first translation model are also replaced with corresponding parameters associated with the phrase in the at least one second model. Examples of the one or more statistical parameters may include forward translation probability and backward translation probability. In an embodiment, to account for the additional probability mass contributed by a phrase pair in the first translation model that has same translations of the phrase, as received from the second translation model, below set of equations are utilized:

$$\begin{matrix}p ( \frac{s}{t} ) = {p}_{k} ( \frac{s}{t} ) & ( 3 ) \\ {∀}_{s} , ∉ s , {p}_{o} ( \frac{{s}^{′}}{t} ) = \frac{{c}_{o} ( {s}^{′} , t )}{{c}_{o} ( t ) + {c}_{k} ( t )} & ( 4 )\end{matrix}$$

where,

s=source phrase, and

t=target phrase, i.e., translation of the phrase.

In an alternate embodiment, the processor 202 may append the one or more translations from the at least one second translation model to the one or more translations in the first translation model. Further, the one or more translations may be appended along with the one or more statistical parameters. In an embodiment, the one or more statistical parameters are recomputed similar to the case when the sentence pairs including the phrases are appended to the corpus used to enrich the first translation model. The computation of the one or more statistical parameters may be performed using below equation:

$${p}_{o} ( \frac{t}{s} ) = \frac{{p}_{o} ( \frac{t}{s} ) * {C}_{o} ( s ) + {p}_{k} ( \frac{t}{s} ) * {c}_{k} ( s )}{{c}_{o} ( s ) + {c}_{k} ( s )} \qquad ( 5 )$$

where

$${p}_{o} ( \frac{t}{s} )$$

=forward translation probability of the phrase in the first translation model,

$${p}_{k} ( \frac{t}{s} )$$

=forward translation probability of the phrase in the second translation model,

Cₒ(s)=count of phrase in the first translation model, and

Cₖ(s)=count of phrase in the second translation model.

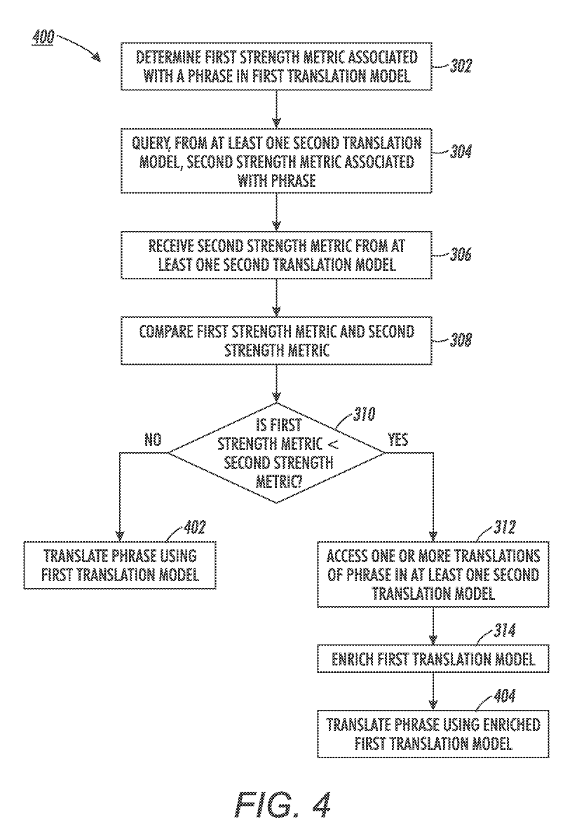

FIG. 4 is a flowchart 400 illustrating a method for translating a phrase, in accordance with at least one embodiment. In an embodiment, the method for translating the phrase is implemented on the application server 104a. The flowchart 400 is described in conjunction with FIG. 1, FIG. 2, and FIG. 3.

In an embodiment, the processor performs the steps 302 to 310 as described in conjunction with the FIG. 3.

If at the step 310, it is determined that the first strength metric is less than the second strength metric, the step 312 is performed, else the step 402 is performed.

At step 402, the phrase is translated using the first translation model. That means, if the processor 202 determines that the first strength metric associated with the phrase is greater in the first translation model than the second strength metric associated with the phrase in the second translation model, the processor 202 translates the phrase using the first translation model. It will be apparent to a person skilled in the art that if the first strength metric is greater than the second strength metric, the phrase has more translation options available in the first translation model and, thus, there is no need to access the at least one second translation models.

At step 312, the at least one second translation model is accessed. The processor 202 accesses the one or more translations of phrase in the at least one second translation model, as discussed in conjunction with FIG. 3.

At step 314, the first translation model is enriched using the accessed one or more translations in the at least one second translation model. Further details about the enrichment of the first translation model have already been discussed in conjunction with FIG. 3.

At step 404, the phrase is translated using the enriched first translation model. Thus, if the processor 202 determines that the first strength metric is less than the second strength metric, then the processor 202 may first enrich the first translation model (using the one or more translations received from the at least one second translation model), and then may subsequently translate the phrase using the enriched first translation model.

Considering an example, the first translation model (hosted on the application server 104a) corresponds to an engineering domain and the second translation model (hosted on the application server 104b) corresponds to medical domain. The user transmits a phrase “diabetes” to the application server 104a. The application server 104a determines the first strength metric for the phrase “diabetes” (e.g., based on equation (2)). Thereafter, the application server 104a queries the application server 104b for the second strength metric. The application server 104b may determine the second strength metric and provide the second strength metric to the application server 104a in response to the query. The application server 104a compares the first strength metric and the second strength metric. Since the phrase “diabetes” belongs to medical domain, the second strength metric for the phrase may be higher than the first strength metric. In such a scenario, the first translation model may access/download the translations corresponding to the phrase “diabetes” from the second translation model. Subsequently, the first translation model may enrich its phrase table based on the translation received from the second translation model. The one or more statistical parameters may also be downloaded, along with the translations of the phrase, as discussed above. Further, as discussed above in conjunction with step 404, the phrase “diabetes” may be translated using the enriched first translation model.

The disclosed embodiments encompass numerous advantages. In general, a statistical machine translation model trained on one domain may not perform well on a different domain. For example, a statistical machine translation model trained on healthcare domain may not perform well when deployed for financial domain. In such scenarios, the statistical machine translation model may typically be adapted for different domains, depending upon the applications in which the statistical machine translation model needs to be deployed. Generally, the statistical machine translation models are adapted (either offline or during the translation) by combining different domain-specific models, in entirety. Since, the providers of the domain-specific models, generally, charge their users based on the number of accesses in the machine translation models, accessing the domain-specific models in entirety may lead to a higher payment for the users. However, the methods and systems presented in the disclosure suggest that the domain-specific models (e.g., the second translation models) are selectively accessed (i.e., when it is determined that those domain-specific models have more translating options for the phrase than the model that needs training/adaptation/enrichment). This type of partial/selective access may reduce the payment for accessing the domain-specific models.

In addition, some of the techniques for adapting the statistical machine translation models require pre-determination of the mixing coefficients before combining the domain-specific models. In such scenarios, there may be need to determine these mixing coefficients every time the statistical model is enriched using a new domain-specific model. However, the presently disclosed embodiments suggest that no upfront determination of the mixing coefficients is required for accessing the domain-specific models, or for receiving the translations from the second translation models.

In addition, by using the pointwise-partitioned conditional entropy as the measure of the strength, it is ensured that the statistical machine translation model (e.g., the first translation model) is enriched if it is determined that the statistical machine translation model has lesser value of at least one of the conditional entropy (i.e., H(T|s)) or the probability of the occurrence of the phrase (i.e., p(s)). Thus, the statistical machine translation model is enriched such that the enriched translation model has better evidences of the translation of the phrases.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for enriching machine translation models have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for enriching a first translation model, the method comprising:
determining, by one or more processors, a first strength metric associated with a phrase in the first translation model;
receiving, by the one or more processors, a second strength metric associated with the phrase, from at least one second translation model; and
enriching, by the one or more processors, the first translation model, based on one or more translations of the phrase received from the at least one second translation model, wherein the one or more translations are received based on a comparison between the first strength metric and the second strength metric.

2. The method of claim 1, wherein each of the first strength metric and the second strength metric corresponds to a pointwise-partitioned conditional entropy.

3. The method of claim 2, wherein the pointwise-partitioned conditional entropy associated with the phrase in a translation model is determined based on a count of translations of the phrase in the translation model and a count of occurrence of the phrase in the translation model.

4. The method of claim 1, wherein the first translation model corresponds to a first domain and the at least one second translation model corresponds to a second domain, and wherein the first domain is different from the second domain.

5. The method of claim 1 further comprising querying, by the one or more processors, the at least one second translation model for the second strength metric associated with the phrase.

6. The method of claim 1, wherein the first translation model is enriched, when the first strength metric is less than the second strength metric.

7. The method of claim 1 further comprising appending to the first translation model, by the one or more processors, the one or more translations of the phrase received from the at least one second translation model.

8. The method of claim 7, wherein the one or more translations are appended along with one or more statistical parameters associated with the phrase received from the at least one second translation model.

9. The method of claim 8, wherein the one or more statistical parameters comprise at least one of a forward translation probability or a backward translation probability.

10. The method of claim 1 further comprising replacing, by the one or more processors, one or more translations of the phrase in the first translation model, with the one or more translations of the phrase received from the at least one second translation model.

11. The method of claim 10, wherein one or more statistical parameters associated the phrase in the first translation model are replaced with one or more statistical parameters associated with the phrase, in the at least one second translation model.

12. A method for translating a phrase, the method comprising:
determining, by one or more processors, a first strength metric associated with the phrase in a first translation model;
receiving, by the one or more processors, a second strength metric associated with the phrase, from at least one second translation model; and
translating, by the one or more processors, the phrase using the first translation model, when the first strength metric is greater than the second strength metric.

13. A system for enriching a first translation model, the system comprising:
one or more processors operable to:
determine a first strength metric associated with a phrase in the first translation model;
receive a second strength metric associated with the phrase, from at least one second translation model; and
enrich the first translation model, based on one or more translations of the phrase received from the at least one second translation model, wherein the one or more translations are received based on a comparison between the first strength metric and the second strength metric.

14. The system of claim 13, wherein each of the first strength metric and the second strength metric corresponds to a pointwise-partitioned conditional entropy.

15. The system of claim 14, wherein the pointwise-partitioned conditional entropy associated with the phrase in a translation model is determined based on a count of translations of the phrase in the translation model and a count of occurrence of the phrase in the translation model.

16. The system of claim 13, wherein the first translation model corresponds to a first domain and the at least one second translation model corresponds to a second domain, and wherein the first domain is different from the second domain.

17. The system of claim 13, wherein the one or more processors are further configured to append the one or more translations of the phrase received from the at least one second translation model, to the first translation model.

18. The system of claim 13, wherein the one or more processors are further configured to replace one or more translations of the phrase with the one or more translations of the phrase received from the at least one second translation model.

19. A computer program product for use with a computer, the computer program product comprising a non-transitory computer readable medium, wherein the non-transitory computer readable medium stores a computer program code for enriching a first translation model, wherein the computer program code is executable by one or more processors to:
determine a first strength metric associated with a phrase in the first translation model;
receive a second strength metric associated with the phrase, from at least one second translation model; and
enrich the first translation model, based on one or more translations of the phrase received from the at least one second translation model, wherein the one or more translations are received based on a comparison between the first strength metric and the second strength metric.
